(19) United States
(12) Patent Application Publication
(10) Pub. No.: US 2013/0288768 A1
(43) Pub. Date: Oct. 31, 2013

(54) METHOD FOR TRACKING LOTTERY PURCHASES AND NOTIFYING WINNERS ELECTRONICALLY

(71) Applicant: E-Squared Tech, Inc., Dallas, TX (US)

(72) Inventors: Sungyun Eric Yoo, Dallas, TX (US); Elmer Y. Cha, Dallas, TX (US)

(21) Appl. No.: 13/935,404

(22) Filed: Jul. 3, 2013

Related U.S. Application Data
(63) Continuation of application No. 13/457,621, filed on Apr. 27, 2012.
(60) Provisional application No. 61/480,481, filed on Apr. 29, 2011.

(51) Int. Cl. G07F 17/32

(52) U.S. Cl. CPC G07F 17/329
USPC 463/17

(57) ABSTRACT

A method for managing game data, comprising electronically receiving and storing purchased lottery ticket data at a processor from a user device. Electronically transmitting ticket confirmation to the user device. Electronically receiving winning lottery number data at the processor. Electronically comparing the winning lottery number data with the stored purchased lottery ticket data with the processor to generate outcome data. Transmitting notification data to the user device that includes the outcome data.

### RELATED APPLICATIONS

This application claims benefit of U.S. Provisional Application Ser. No. 61/480,481, filed Apr. 29, 2011, and U.S. patent application Ser. No. 13/457,621, filed Apr. 27, 2012, each of which are hereby incorporated by reference for all purposes as if set forth herein in their entirety.

### TECHNICAL FIELD

The present disclosure relates generally to gaming systems, and more specifically to a system and method for tracking lottery ticket purchases for users and for electronically notifying users of winning tickets.

### BACKGROUND OF THE INVENTION

Lottery tickets are sold in many countries to allow players to purchase a chance to win a large prize pool. The lottery tickets are typically paper tickets, and if a player loses the ticket or forgets to check their number, then the prize for that ticket will go unclaimed.

### SUMMARY OF THE INVENTION

A method for managing game data, comprising electronically receiving and storing purchased lottery ticket data at a processor from a user device. Electronically transmitting ticket confirmation to the user device. Electronically receiving winning lottery number data at the processor. Electronically comparing the winning lottery number data with the stored purchased lottery ticket data with the processor to generate outcome data. Transmitting notification data to the user device that includes the outcome data.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE SEVERAL VIEWS OF THE DRAWINGS

Aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views, and in which:

FIG. 1 is a diagram of an algorithm for tracking lottery purchases and notifying winners electronically in accordance with an exemplary embodiment of the present invention;

FIG. 2 is a diagram of system for providing lottery tracking and notification services in accordance with an exemplary embodiment of the present invention; and

FIG. 3 is a diagram of an algorithm for generating a coupon in accordance with an exemplary embodiment of the present disclosure.

### DETAILED DESCRIPTION OF THE INVENTION

In the description that follows, like parts are marked throughout the specification and drawings with the same reference numerals. The drawing figures might not be to scale and certain components can be shown in generalized or schematic form and identified by commercial designations in the interest of clarity and conciseness.

FIG. 1 is a diagram of an algorithm 100 for tracking lottery purchases and notifying winners electronically in accordance with an exemplary embodiment of the present invention. Algorithm 100 can be implemented in hardware or a suitable combination of hardware and software, and can be one or more software systems operating on a general purpose processing platform.

As used herein, “hardware” can include a combination of discrete components, an integrated circuit, an application-specific integrated circuit, a field programmable gate array, or other suitable hardware. As used herein, “software” can include one or more objects, agents, threads, lines of code, subroutines, separate software applications, two or more lines of code or other suitable software structures operating in two or more software applications or on two or more processors, or other suitable software structures. In one exemplary embodiment, software can include one or more lines of code or other suitable software structures operating in a general purpose software application, such as an operating system, and one or more lines of code or other suitable software structures operating in a specific purpose software application. As used herein, the term “couple” and its cognate terms, such as “couples” and “coupled,” can include a physical connection (such as a copper conductor), a virtual connection (such as through randomly assigned memory locations of a data memory device), a logical connection (such as through logical gates of a semiconducting device), other suitable connections, or a suitable combination of such connections.

Algorithm 100 begins at 102, where a user registers an account. In one exemplary embodiment, the present disclosure provides a method for electronically tracking lottery purchases and notifying registered players of winning numbers by a short message service (SMS) message, a mobile application notification, e-mail or other suitable processes. As used herein, a mobile application refers to a software program or programs that operate on a computing device, where the computing device can be a cellular telephone, a tablet computer, or other suitable devices that are typically portable and that have low power requirements. A mobile application can be optimized for use with such portable devices, such as to reduce the computing and power requirements associated with running the mobile application. However, a mobile application can also or alternatively be operated on a general purpose processing platform, such as a desktop computer, a laptop computer, a server computer, or other suitable systems.

A lottery player may check a purchased ticket for the jackpot numbers only, and may be unaware that there are other winning prizes offered. These prizes can range from reimbursement of the cost of the lottery ticket to a few thousand dollars. Unless the player checks for all winning numbers, the player may not realize that their lottery ticket contains winning numbers. Algorithm 100 allows lottery players to track their purchased lottery tickets and to be notified after the drawings if they hold winning lottery tickets, non-winning lottery tickets, or in other suitable situations.

In one exemplary embodiment, a user can register an account by accessing a website to electronically submit registration data, such as to create a profile that includes a username, a password, an email address, a mobile number, a type of mobile phone and other suitable data. The algorithm then proceeds to 104, where it is determined whether the user has a smart phone, a tablet computer, a desk top computer or other processing devices that are capable of providing complex functionality. In this exemplary embodiment, the user may access a web server or application server in a number of different ways. For example, if it is determined that the user is using a smart phone, the algorithm proceeds to 106. The algorithm can detect the use of a smart phone in a number of suitable manners. In one exemplary embodiment, a user of a smart phone, which can include an Apple iPhone device, a device that uses the Android operating system, or other suitable personal communication devices with enhanced computing capacity, can be prompted to access a website at the point of purchase for a lottery ticket, such as by a physical display at the point of purchase. In this exemplary embodiment, the user can enter a website address into a web browser application of the smart phone device, the user can scan a two dimensional bar code tag that is translated by an application that operates on the user's smart phone into an electronic device of a web server or application server, or other suitable algorithmic processes can also or alternatively be used. The smart phone can include an image data device that generates a frame of image data, that scans a field of view, that performs optical character recognition (OCR), or that otherwise processes image data.

In this exemplary embodiment, the user can download a mobile application to the user's smart phone once the user has accessed the web site, and can then register electronically. After downloading the mobile application, the user can execute the mobile application using the smart phone operating system or in other suitable manners. When the mobile application is executed for the first time, the mobile application can execute one or more algorithms for obtaining information from the user to establish an account for the user, or to access an existing account for the user. During this initial processing, the mobile application can prompt the user to enter data through a plurality of data entry fields, such as the user's name, a mailing address, an email address, a cellular telephone number, an electronic communications address, electronic payment account information, or other suitable data. Likewise, the mobile application can be configured to interface with a social network or other third party systems, such that the mobile application can include one or more applications program interfaces (API) to the social network, to allow the mobile application to obtain account data from the social network. In another exemplary embodiment, the mobile application can be replaced by an application that operates within the social network environment, such as to allow the user to access the functionality of the mobile application without having to download the mobile application to the user's smart phone or other device. Likewise, a web server application can also or alternatively be used. After registration of the application, a confirmation email, text message or other electronic message can be sent to the user's email address or other suitable communications applications to confirm account registration.

If it is determined at 104 that a smart phone is not being used, the algorithm proceeds to 110, where an SMS confirmation or other suitable processes are used to confirm account registration. In this exemplary embodiment, a user can use a cellular device with limited processing capability to establish an account, such as by sending an SMS message to an address that is identified on a physical display, where the cellular telephone number of the user's cellular telephone is used to establish an initial account profile. The user can then be provided with a response SMS message that instructs the user to access a web site through a web browser, to call an operator, or to other provide additional account information for access to enhanced functional features. In this exemplary embodiment, the user can transmit lottery ticket numbers by manually entering the numbers, by using an image data device of the cellular telephone to transmit an image of the lottery ticket to an application server, or to otherwise interface with a lottery tracking and notification system.

Based on the information provided during registration, if the player uses a smart-phone, an application link may be sent from a server to the registered mobile number as SMS or email. When player clicks on the link, the player may have the option to install a mobile-application on the phone. However, if the player does not have a smart-phone, the server may send an email to the registered address, and an SMS message confirming the mobile number and the inability to install the mobile application. Thus, a player is distinguished as a mobile-application user if using a smart-Phone or a non-mobile-application user if using a non-smart-phone.

After registration, the algorithm proceeds to 108 or 112, depending on the type of device operated by the user. In one exemplary embodiment, the user can go to a retail store or online to purchase a lottery ticket. At 108, the user can take a picture of the ticket using an image data device of the smart phone, such as a camera that generates a frame of image data, a scanner that uses OCR to detect alphanumeric data, or in other suitable manners. The image data, the OCR character data, global positioning system (GPS) data or other location data, and other suitable data can be transmitted to the server using the mobile application. The mobile application user can also or alternatively transmit a file of image data via multimedia messaging service (MMS) to a designated short code, ticket data can be manually entered using the mobile application, or other suitable processes can be used. At 112, the user can take a picture of the ticket using a camera device of the user's cellular telephone and can send the picture via MMS to the designated short code, the user can manually type in the lottery ticket information and send it to the server via SMS, or other suitable processes can be used. The algorithm then proceeds to 114.

At 114, the application server, web server or other suitable systems (such as a lottery tracking and notification system) can convert the image data sent by the users into text using optical character recognition (OCR). The algorithm then proceeds to 116, where the OCR data generated at the web server, application server or other suitable systems can be compared to the OCR data from a smart phone, manually-entered data, or other suitable data, and if discrepancies exist, an electronic message can be generated to prompt the user to provide an electronic message that resolves the discrepancies. In addition, the user can access a website to resolve discrepancies, to manually enter lottery ticket information, or to perform other suitable functions.

In one exemplary embodiment, the web server, application server or other suitable system can send the processed lottery ticket information to the user using the mobile application, an SMS message, an email message or other suitable message to prompt the user to confirm that the processed lottery ticket information matches the hard copy or purchased lottery ticket information. In one exemplary embodiment, the scanned lottery ticket data can be displayed adjacent to the extracted lottery ticket numbers, such as by displaying a first line with a first scanned lottery ticket number and a second line underneath the first line with the OCR extracted lottery ticket numbers, to allow a user to quickly compare the image data with the OCR extracted numbers. If the information matches, no additional action from the user can be required. If the information does not match, the user can correct inaccurate numbers using the mobile application, can send the corrected information via SMS message, can log on to a web site through a web browser and modify the information using the website, or can correct the information using other suitable processes. The algorithm then proceeds to 118.

At 118, winning lottery numbers are obtained after the drawing for the lottery game. In one exemplary embodiment, the web server, application server or other suitable systems can include one or more APIs that interface with a state lottery system or other third party data sources to obtain the winning lottery numbers and prize information. After the winning lottery numbers have been obtained, the stored lottery ticket is compared with the winning number data to determine whether any tickets are winning tickets. In one exemplary embodiment, the lottery ticket data can be stored in a relational database that has predetermined fields that identify the lottery numbers from relevant fields of the lottery tickets, such as the lottery ticket numbers, an enhanced value field (such as when the lottery game allows a player to pay an additional amount to multiply the prize amount), the drawing date for the lottery ticket, and other suitable data. The values stored in the database fields for each lottery ticket can then be extracted using a suitable algorithm, such as a search algorithm that compares each field number of the lottery ticket with the winning lottery drawing numbers, an algorithm that updates a field with the count of matching numbers, an algorithm that compares the number of matching numbers with the prize amounts for the lottery game, an algorithm that stores the prize amount with the lottery ticket record, an algorithm that sums all prize amounts for all of the user's lottery tickets for that drawing, or other suitable algorithms. The algorithm then proceeds to 120, where a notification message is transmitted to the user, such as using SMS, a mobile application, an or email or in other suitable manners. The notification can include the winning numbers and the amount won, including non-jackpot-commission based winnings. If an insufficient number of lottery ticket fields match the winning numbers to win a prize, a suitable notification can be transmitted, such as a reminder of the date of the next lottery game drawing, the new jackpot amount, or other suitable data.

In addition, the algorithm can update the user's account history to enable the user to see the previously played numbers, results and other suitable information. In an alternate embodiment, the mobile application can download the winning numbers, compare them to the numbers in the user's ticket information, and notify the user if the ticket includes a winning combination as well as any amount won.

In operation, algorithm 100 allows a user to store lottery ticket data to allow the lottery ticket data to be compared with drawn lottery numbers for a lottery game and to receive a notification with the results. Algorithm 100 helps to alert users to lottery game winnings, to avoid the inadvertent loss of awards.

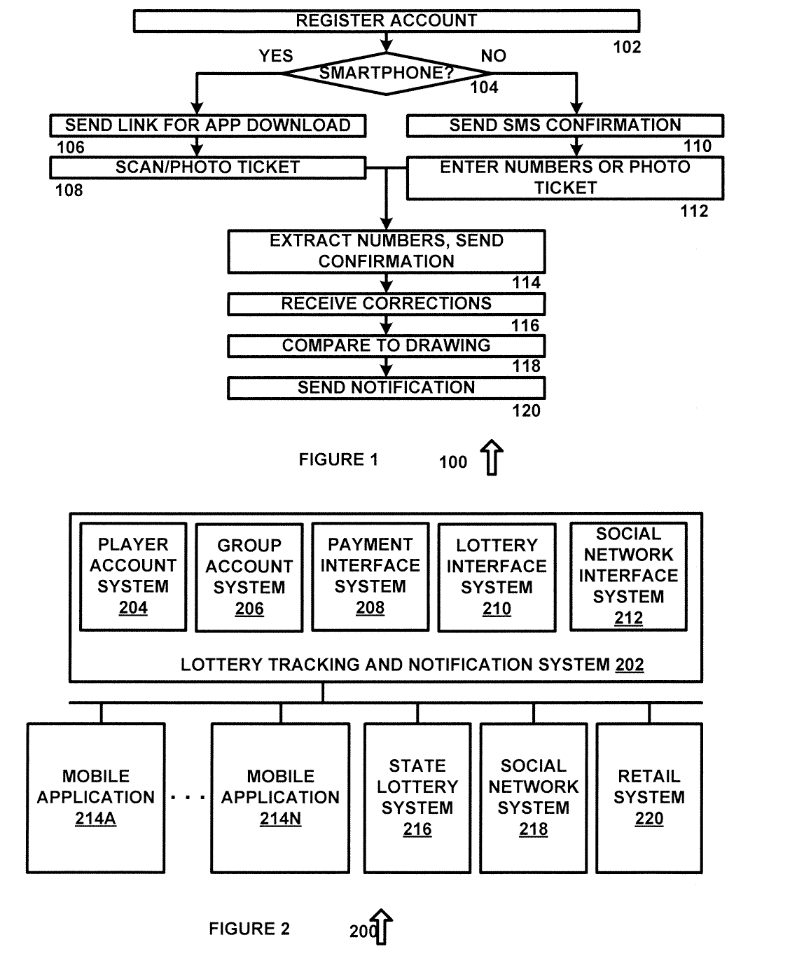

FIG. 2 is a diagram of system 200 for providing lottery tracking and notification services in accordance with an exemplary embodiment of the present invention. System 200 includes lottery tracking and notification system 202, player account system 204, group account system 206, payment interface system 208, lottery interface system 210, social network interface system 212, mobile applications 214A through 214N, state lottery system 216, social network system 218 and retail system 220, each of which can be implemented in hardware or a suitable combination of hardware and software, and which can be one or more software systems operating on a processor.

Lottery tracking and notification system 202 allows users to set up accounts for providing information identifying lottery tickets that are purchased by the user and for receiving notifications regarding the results of associated lottery drawings. In one exemplary embodiment, lottery tracking and notification system 202 can be implemented as a website that allows a user to set up an account using a web browser by entering account data into data fields of a web page or in other suitable manners. In another exemplary embodiment, lottery tracking and notification system can be implemented as an application server with one or more associate mobile applications, such as applications that operate on the iPhone mobile platform, the Android mobile platform, or other suitable smart phone platforms. In this exemplary embodiment, a user can download the mobile application from a website, an application store or other suitable sources, and can be prompted to enter account information when the user activates the mobile application for the first time. In another exemplary embodiment, lottery tracking and notification system 202 can operate in conjunction with a social networking system, such as Facebook, where a user can activate an application with the social networking system and can utilize the social network account data to provide account data for lottery tracking and notification system 202.

Lottery tracking and notification system 202 can also provide advertising data to users, such as coupons or advertisements. The advertising data can be selected based on nearby stores, in response to GPS data or other positioning data. In one exemplary embodiment, lottery tracking and notification system 202 can create reminders for user that routinely play a lottery game, and can generate a notification for the user at a predetermined time (such as two hours before the next drawing) to remind the user to purchase a ticket. The notification can include directions to the closest store that is selling lottery tickets, the closest store that has paid a membership fee to be included in the notification service, or in other suitable manners, such as where priority is given to the closest member store, and where the closest non-member store is provided if the closest member store is more than a predetermined distance from the user. Other suitable advertising can also or alternatively be provided. In one exemplary embodiment, an advertising promotion can be targeted to users that have lottery ticket numbers that match predetermined numbers (such as the scores of each team at the end of a sporting event), users that have won or lost the lottery drawing, based on the user's birthday or location, or other suitable advertising.

In another exemplary embodiment, lottery tracking and notification system 202 can electronically store ticket image data in a secure manner, as insurance against ticket fraud, ticket theft, ticket loss, ticket destruction or other events. In this exemplary embodiment, lottery tracking and notification system 202 can include one or more security controls that may be mandated by a state lottery agency to allow lottery tracking and notification system 202 to be used in this manner.

Player account system 204 allows a user to store relevant account data, purchased lottery ticket data and other suitable data for managing lottery ticket data and notifications. In one exemplary embodiment, player account system 204 can allow a user to enter account data fields, to modify account data fields, to enter lottery ticket data fields, to correct lottery ticket data fields, to enter notification data fields, or to perform other suitable functions. In this exemplary embodiment, the user can navigate to user entry screens that provide a user interface for adding or modifying account data, such as by entering an account identifier and a password, by selecting navigation links, or in other suitable manners.

In one exemplary embodiment, a user can select an account setting that allows ticket image data that is submitted by the user to be saved, so as to allow the user to edit or correct ticket data. Likewise, the ticket image data and any corrections entered by the user can also be used by lottery tracking and notification system 202 to improve any OCR processing that is performed at lottery tracking and notification system 202, such as by application of a learning algorithm, neural network algorithm or in other suitable manners.

Player account system 204 can also allow a user to configure one or more controls. In one exemplary embodiment, the notification processes can be configured by the user, such as to allow the user to elect to receive an email message, SMS message, a notification from a mobile application, an automated or live telephone call, different message types for different award levels, or other suitable notifications. Likewise, seeing impaired users can configure player account system 204 to read entered lottery ticket numbers, winning numbers or other suitable data back to the user, in a user-selected language, or in other suitable manners.

In another exemplary embodiment, player account system 204 can allow a user to transfer title to a lottery ticket to another user, or to promise another user a share in any lottery the winnings. In this exemplary embodiment, the other users can receive a notification of the transferred title or interest in winnings, and the users can electronically sign agreements in conjunction with the transfer of title or outcome interests.

Group account system 206 allows two or more users to establish a group account for jointly holding lottery ticket information. In one exemplary embodiment, group account system 206 can allow a first user to create a group identifier, and to add or invite other users to be members of the group. In this exemplary embodiment, the first user can be the group administrator, the group administrator function can be transferred from the first user to a subsequent group member, the group administrator function can be assigned to a user or users that have obtained group administrator certification or training, or other suitable processes can also or alternatively be used. Users can be invited by a suitable message, can be added by the group administrator by entering user identifiers or by selecting from a list, or in other suitable manners. In one exemplary embodiment, each group member can be provided with a group identifier and unique password, or each user can assign their own group identifier, can have a common password, or other suitable group access protocols and procedures can be used. In another exemplary embodiment, group members can use social networking system functionality to add members or administer group functions, proximity based protocols can be used to add members, or other suitable procedures can be used. Group account system 206 allows group members to buy lottery tickets for the group and to upload lottery number data, ticket image data, or other suitable data to avoid problems that can arise when a group member separately owns a winning lottery ticket. Likewise, group members can pool lottery tickets, such as where the percent ownership in lottery award proceeds is determined as a function of the number of lottery tickets contributed by each group member. Other suitable processes can also or alternatively be used to allocate winnings from non-jackpot awards, such as to randomly assign the non-jackpot winnings to one or more group members, to assign the non-jackpot winnings to group members on a round robin basis, to allow group members to create a “lottery” type award for jackpot or non-jackpot winnings with user-defined contractual terms, to print tickets for group membership or winnings with suitable unique identifiers, or to perform other suitable functions.

Payment interface system 208 provides interface functionality to payment systems for use by users, groups or other suitable entities. In one exemplary embodiment, an API to a payment service such as PayPal, a credit card payment processor or other suitable services can be used to allow group members to contribute to a lottery pool. In this exemplary embodiment, cash payments for lottery tickets can be made by one or more group members, and other group members can buy into the lottery pool using the payment system, such as where non-cash payments for lottery tickets are prohibited by law. Likewise, other payment mechanisms such as social network payment accounts can also or alternatively be used.

Lottery interface system 210 interfaces with a state lottery system, a third party data system, or other suitable systems to obtain lottery drawing data, lottery prize pool or award data, or other suitable data. In one exemplary embodiment, an API or other suitable interfaces can be used to obtain lottery data directly from a state lottery system, a web page template can be used to read predetermined data fields from a state lottery system website, or other suitable processes can be used to obtain lottery data.

Social network interface system 212 allows a user, group or other entities to interface with a social network. In on exemplary embodiment, member data fields for members of a social network can be used to identify prospective group members, such as social network members that worked for a company, attended a school, or other suitable groups. In another exemplary embodiment, a social graph can be used to identify prospective group members. An API can also or alternatively be used to interface system 200 to a social network, such as where lottery prize data is posted to a social network member's account, to allow system 200 to be operated in conjunction with a social network (such as to be an application within the social network), or in other suitable manners.

Mobile applications 214A through 214N (where N is an integer greater than one) allow users to interface with system 200, such as by creating and accessing user accounts, to submit image data for purchased lottery tickets, to receive notifications of winning ticket numbers, to review OCR data for tickets to confirm the accuracy of ticket numbers, to receive related advertising, or for other suitable purposes. In one exemplary embodiment, the ticket data can be processed using OCR processing at the mobile application 214, which can identify the ticket date and type, the date and location where the ticket was purchased, the date and location where image data for the ticket was submitted from, or other suitable data.

State lottery system 216 provides winning lottery draw numbers, prize amounts, and other suitable data. In one exemplary embodiment, state lottery system 216 can validate ticket information, such as the time and location where a ticket was purchased, security code information on the lottery ticket, and other suitable data. In this exemplary embodiment, state lottery system 216 can validate ticket data received from image data, so as to improve the security of submitted ticket data and to prevent fraud.

Social network system 218 provides data or other functionality for use with system 200. In one exemplary embodiment, social network system can 218 provide user account data, can support group functionality, can provide a portal for access to system 200, or can provide other suitable functions.

Retail system 220 can provide retail processing functionality for lottery tickets, coupons, retail items and other items. In one exemplary embodiment, retail system 220 can include a bar code scanner or other suitable devices for reading lottery tickets, coupons, retail items and other items, such as to support lottery ticket redemption, coupon redemption, user profile data assembly and other suitable functionality.

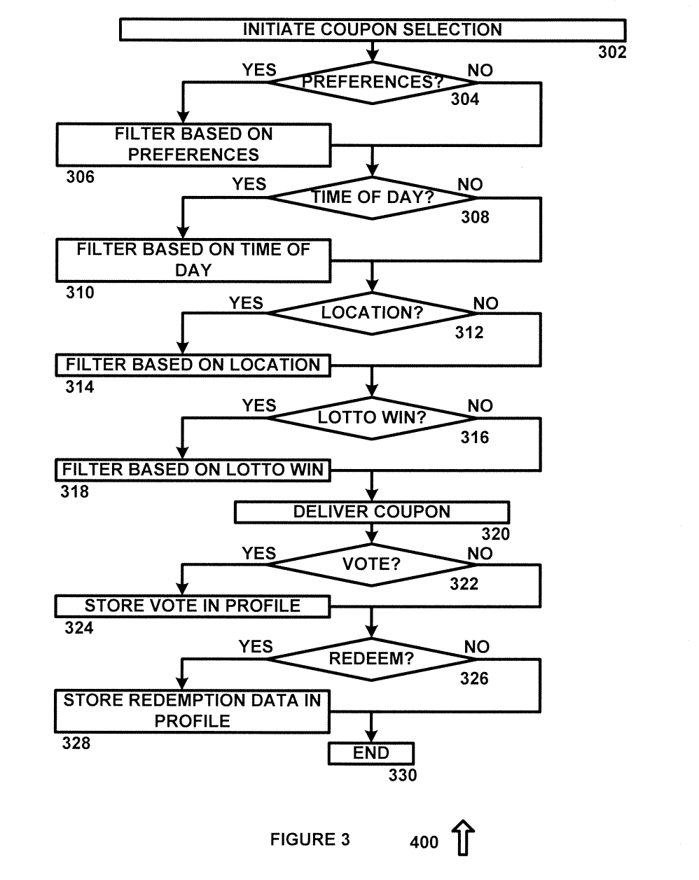

FIG. 3 is a diagram of an algorithm 300 for generating a coupon in accordance with an exemplary embodiment of the present disclosure. Algorithm 300 can be implemented in hardware or a suitable combination of hardware and software, and can be one or more software systems operating on a general purpose processing platform.

Algorithm 300 begins at 302, where coupon selection is initiated. In one exemplary embodiment, coupon selection can be initiated when user lottery ticket numbers are processed to determine whether they match a lottery drawing, when it is determined that a user is within a predetermined distance from a retail location based on user GPS data or other suitable location data, or in other suitable manners. The algorithm then proceeds to 304.

At 304, it is determined whether user preferences for a coupon have been associated with the user profile. In one exemplary embodiment, a user can indicate a preference for a coupon by voting (e.g. “like” or “dislike”) when a coupon is received by the user at a user device. In this manner, a user's preference for types of coupons (e.g. drink coupons versus snack coupons, types of drinks, types of snacks, etc.) can be received from a user device after a coupon has been transmitted to the user device, and can be stored in the user profile, such as in a list or file or coupon preferences. If it is determined that no user preferences exist, the algorithm proceeds to 308, otherwise the algorithm proceeds to 306 where the coupon selection is filtered based on the preferences. In one exemplary embodiment, a set of available coupons can be filtered by excluding coupon types that have not previously been approved by the user, by excluding coupon types that have previously been disapproved by the user, or in other suitable manners. The algorithm then proceeds to 308.

At 308, it is determined whether a time of day filter should be applied. In one exemplary embodiment, a time of day filter can be applied during predetermined time periods, such as from 6 am to 8 am for breakfast items, from 11 am to 1 pm for lunch items, from 2 pm to 4 pm for mid-day snack items and so forth. If it is determined that a time of day filter should not be applied, the algorithm proceeds to 312, otherwise the algorithm proceeds to 310 where coupons are filtered based on the time of day. In one exemplary embodiment, a list of predetermined types of coupons for a corresponding time of day can be selected, such as coffee coupons, donut coupons or other suitable coupons for the breakfast time period, sandwich coupons, potato chip coupons or other suitable coupons for the lunch time period and so forth. The algorithm then proceeds to 312.

At 312, it is determined whether a location filter should be applied. In one exemplary embodiment, a location filter can be applied for predetermined locations, such as for locations near a sporting event, locations having additional stock of seasonal items, and so forth. If it is determined that a location filter should not be applied, the algorithm proceeds to 316, otherwise the algorithm proceeds to 314 where coupons are filtered based on the location. In one exemplary embodiment, a list of predetermined types of coupons for a corresponding location can be selected, such as bottled beverage coupons for locations near a sporting event, themed desserts for locations having seasonal themed desserts, or other suitable coupons. The algorithm then proceeds to 316.

At 316, it is determined whether a lotto win filter should be applied. In one exemplary embodiment, a lotto win filter can be applied for predetermined lotto prizes, such as for items having prices equal to the lotto prize. If it is determined that a lotto prize filter should not be applied, the algorithm proceeds to 320, otherwise the algorithm proceeds to 318 where coupons are filtered based on the lotto prize amount. In one exemplary embodiment, a list of predetermined types of coupons for a corresponding lotto prizes can be selected, such as one dollar bottled beverage coupons for lotto prizes of one dollar, two dollar sandwich coupons for lotto prizes of two dollars, or other suitable coupons. The algorithm then proceeds to 320.

At 320, the selected coupon is delivered to the user, such as by email, a text message, a device-specific application or in other suitable manners. The algorithm then proceeds to 322 where it is determined whether a vote has been received from the user. In one exemplary embodiment, the user can have device-specific application that generates voting buttons for the coupon, such as “like” or “dislike,” where the user can indicate whether the coupon is one that the user will ultimately use or one that the user will not use. In this manner, even if the user does not ultimately use the coupon, such as due to expiration, the user's interest in receiving that type of coupon can be recorded and stored to the user's profile. If it is determined that no vote has been received, such as within a predetermined time, the algorithm proceeds to 326, otherwise the algorithm proceeds to 324 where the user vote data is stored in the user's profile, such as in a file of coupon types that the user has “liked,” a file of coupon types that the user has “disliked” or in other suitable manners. Likewise, 322 and other suitable algorithm processes can be implemented as objects having state, associated graphic and functional attributes and other suitable attributes, to allow the user to vote on the coupon at any suitable time and without requiring algorithm 300 to wait for a response, time out or otherwise be implemented in any particular manner or using any particular type of programming architecture. The algorithm then proceeds to 326.

At 326, it is determined whether the coupon has been redeemed, such as when a scanner at a retail location point of sale system or other suitable systems has scanned the coupon, read a bar code associated with the coupon, received near field communications data associated with the coupon or in other suitable manners. As previously discussed, 326 can be implemented in other suitable manners, such as by implementing a coupon object that waits in a quiescent state until it has expired or has been used, by storing coupon data in a database that is accessed when the coupon is used, or in other suitable manners. If it is determined that the coupon has not been redeemed, such as after the coupon expires, the algorithm proceeds to 330 where the coupon is decommissioned, where non-usage data associate with the coupon, the user or other suitable systems is stored, or other suitable processes are implemented. Otherwise, the algorithm proceeds to 328 where redemption data is stored in a user profile. In one exemplary embodiment, coupon redemption data can be separate from coupon voting data, such as to identify coupons that a user “liked” but did not use, that the user “disliked” but subsequently used, or other suitable data. In another exemplary embodiment, coupon use data can be stored with other suitable data, such as point of sale data identifying items that were purchased with the item for which the coupon was used, such as to identify other potential coupons that can be offered to the user, to a class of users or in other suitable manners.

In operation, algorithm 300 allows coupons to be generated for lotto players, regardless of whether the player wins or loses, so as to create an incentive for the player to visit a retail location. Algorithm 300 allows coupons to be selected based on user preferences, time of day, location or other data, so as to create a more effective incentive for attracting shoppers to retail locations.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

What is claimed is:

1. A method for managing game data, comprising:
electronically receiving and storing purchased lottery ticket data at a processor from a user device;
electronically transmitting ticket confirmation to the user device;
electronically receiving winning lottery number data at the processor;
electronically comparing the winning lottery number data with the stored purchased lottery ticket data with the processor to generate outcome data; and
transmitting notification data to the user device that includes the outcome data.

2. The method of claim 1 further comprising:
electronically receiving a registration request from a user device using a processor; and
electronically transmitting a registration confirmation to the user device.

3. The method of claim 1 further comprising:
electronically receiving a request for a mobile application from the user device at the processor; and
electronically transmitting the mobile application to the user device from the processor.

4. The method of claim 3 further comprising:
electronically receiving initialization data from the mobile device when the mobile device activates the mobile application for the first time; and
electronically prompting the user device for account configuration data.

5. The method of claim 1 further comprising:
electronically receiving a request for access to lottery notification service from a user account of a social network system; and
electronically configuring the user account of the social network service to access the lottery notification service.

6. The method of claim 1 further comprising:
electronically receiving a request to form a group account at the processor;
electronically receiving a plurality of identifiers of group members at the processor; and
electronically creating the group account at the processor, wherein the group account includes the plurality of identifiers of group members.

7. The method of claim 6 further comprising:
electronically receiving lottery ticket data at the processor from a user account associated with one of the identifiers of group members; and
electronically associating the lottery ticket data with user accounts associated with the other identifiers of group members.
